(19) United States
(12) Patent Application Publication
(10) Pub. No.: US 2006/0190601 A1
(43) Pub. Date: Aug. 24, 2006

(54) Localized authentication, authorization and accounting (AAA) method and apparatus for optimizing service authentication and authorization in a network system

(75) Inventors: Byoung-Joon Lee, Seongnam-si (KR); Alper Yegin, San Jose, CA (US)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/358,923

(22) Filed: Feb. 22, 2006

Related U.S. Application Data
(60) Provisional application No. 60/656,108, filed on Feb. 24, 2005.

(30) Foreign Application Priority Data
Nov. 16, 2005 (KR) 2005-109727

(51) Int. Cl. G06F 15/173

(52) U.S. Cl. 709/225

(57) ABSTRACT

An authentication and authorization method/apparatus, in a network system which includes a mobile terminal and a home authentication, authorization and accounting (AAA) server, includes: receiving a network access service request signal from the mobile terminal; forwarding the received network access service request signal to the home AAA server which corresponds to the network access service request signal; receiving a service list corresponding to the network access service request signal; and sending a network access service authorization signal to the mobile terminal when the service authorization of the mobile terminal is verified based on the received service list. The single network access service authorization is used for subsequent service authorizations so that the service delay due to the AAA protocol exchanges can be reduced. Delivery of the service list accompanied by an automatic security key generation mechanism achieves local authentication and authorization of local services without involving the home AAA server.

### CROSS-REFERENCE TO RELATED APPLICATIONS

This application claims the benefit of U.S. Provisional Application No. 60/656,108 filed Feb. 24, 2005 in the United States Patent and Trademark Office and Korean Patent Application No. 2005-109727, filed Nov. 16, 2005 in the Korean Intellectual Property Office, the disclosures of which are incorporated herein by reference.

### BACKGROUND OF THE INVENTION

1. Field of the Invention

Aspects of the invention generally relate to an authentication and authorization method and apparatus of a network system and the network system. More particularly, the aspects of the invention relate to an authentication and authorization method and apparatus of a network system to reduce service delay due to authentication, authorization and accounting (AAA) protocol exchanges by delivering an authorized service list (ASL) and automatically generating security keys for local such services.

2. Description of the Related Art

FIG. 1 is a signal flow diagram illustrating a conventional authentication and authorization method in a conventional network system.

The network system in FIG. 1 includes a mobile terminal (MT) 10, a network access server (NAS) 20, a home agent (HA) 30, a session initiation protocol (SIP) server 40, a local authentication, authorization and accounting (AAA) server 50, and a home AAA server 60.

The MT 10 can be but is not limited to a mobile phone. The NAS 20 is a computer server of Internet service providers (ISPs) that provides interfacing and login confirmation between a communication service provider and an Internet backbone. Also, the NAS 20 identifies and authenticates a user, such as by typically verifying a user name and a password, and thus allows communications with computers via the Internet. The NAS 20 can be configured to provide various services, such as voice over IP (VoIP), fax-over-IP, and voicemail-over-IP, with “IP” being “Internet Protocol” in VoIP, fax-over-IP, and voicemail-over-IP.

The HA 30 is a virtual router on a mobile node's home network in a mobile IP network. The HA 30 is responsible to maintain current location information of the mobile node by registering its auxiliary address thereto when the mobile node leaves the home network, and capsules a datagram so that the mobile node can still communicate with its sub-network in another sub-network.

The session initiation protocol (SIP) is an application layer control protocol based on a typically simple text. The SIP server 40 is a SIP-based server to enable more than one participant to establish, modify, and terminate sessions.

The local AAA server 50 and the home AAA server 60 are authentication, authorization and accounting (AAA) servers which service AAA functions when dealing with the user's access to computer resources and providing services. Typically, the AAA server interacts with databases and directories containing user information by interacting with network access and gateway servers.

When the MT 10 attaches to an access network, there are several local services made available to the user of the MT 10. The available local services include network access service, dynamic host configuration protocol (DHCP) service, mobile IP service, SIP service, and web service. For service differentiation and granularity authentication, authorization and accounting according to the service utilization, each service is typically provided from the local AAA server 50. In other words, when the user contacts each service access point (SAP), such as the NAS 20, the HA 30, and the SIP server 40, the SAP should request the local AAA server 50 to authorize the requested service.

To allow the user to receive services provided from the local AAA server 50, in principle, the authentication and the authorization of the local AAA server 50 for the user are typically required. However, when the local AAA server 50 does not hold a service list authorized to the MT 10 and the associated security keys to protect the services, the local AAA server 50 should rely on the home AAA server 60 to obtain the required information all the time. In most general wireless networks, the SAP and the home AAA server 60 of the user are different internet protocol (IP) sub-networks. In other words, several hops can exist between the SAP and the home AAA server 60 of the user which can be typically located in different parts of the Internet.

Continuing with reference to FIG. 1, there is illustrated a conventional authentication and authorization method in a conventional network system. When the user needs, or requests, an access network service, the MT 10 sends a network access service request signal to the NAS 20 at its moved location (operation S100). Upon receiving the network access service request signal from the MT 10, the NAS 20 forwards the network access service request signal to the local AAA server 50 (operation S105). Upon receiving the network access service request signal from the NAS 20, the local AAA server 50 forwards the received network access service request signal to the home AAA server 60 corresponding to the MT 10 using information relating to the MT 10 (operation S110).

The home AAA server 60 verifies whether the corresponding MT 10 is authorized for the network access service based on the information relating to the MT 10. When the MT 10 is authorized for the network access service, the home AAA server 60 sends a network access service authorization signal to the local AAA server 50 (operation S115). Upon receiving the network access service authorization signal from the home AAA server 60, the local AAA server 50 forwards the received network access service authorization signal to the NAS 20 (operation S120). The NAS 20 also forwards the received network access service authorization signal to the MT 10 (operation S125).

When the user needs a mobile Internet Protocol (IP) service, the MT 10 sends a mobile IP service request signal to the HA 30 (operation S130). Upon receiving the mobile IP service request signal from the MT 10, the HA 30 forwards the received mobile IP service request signal to the local AAA server 50 (operation S135). Upon the receipt of the service request signal from the HA 30, the local AAA Server 50 forwards the received mobile IP service request signal to the home AAA server 60 corresponding to the MT 10 based on the information relating to the MT 10 (operation S140).

The home AAA server 60 verifies whether the corresponding MT 10 is authorized for the mobile IP service based on the information relating to the MT 10. When the MT 10 is authorized for the mobile IP service, the home AAA server 60 sends a mobile IP service authorization signal to the local AAA server 50 (operation S145). Upon receiving the mobile IP service authorization signal from the home AAA server 60, the local AAA server 50 forwards the received mobile IP service authorization signal to the HA 30 (operation S150). The HA 30 also forwards the received mobile IP service authorization signal to the MT 10 (operation S155).

When the user needs a session initiation protocol (SIP) service, the MT 10 sends a SIP service request signal to the SIP server 40 (operation S160). Upon receiving the SIP service request signal from the MT 10, the SIP server 40 forwards the received SIP service request signal to the local AAA server 50 (operation S165). Upon the receipt of the request signal from the SIP server 40, the local AAA Server 50 forwards the received SIP service request signal to the home AAA server 60 corresponding to the MT 10 based on the information relating to the MT 10 (operation S170).

Next, the home AAA server 60 verifies whether the corresponding MT 10 is authorized for the SIP service based on the information relating to the MT 10. When the MT 10 is authorized for the SIP service, the home AAA server 60 sends a SIP service authorization signal to the local AAA server 50 (operation S175). Upon receiving the SIP service authorization signal from the home AAA server 60, the local AAA server 50 forwards the received SIP service authorization signal to the SIP server 40 (operation S180). The SIP server 40 also forwards the received SIP service authorization signal to the MT 10 (operation S185).

As discussed above with reference to FIG. 1, every time the MT 10 requests the network access service, the mobile IP service and the SIP service, the service request and the service authorization are iterated between the local AAA server 50 and the home AAA server 60. Typically, for the access of the MT 10 to AAA-enabled local services, AAA protocol exchanges are demanded between the SAP, such as NAS server 20, HA 30 and SIP server 40, and the home AAA server 60 of the user. However, such AAA protocol exchanges can delay the service availability.

The delay of the service availability typically results from the AAA signal exchanges which are required for each service access request of the user, in view of the generally long distance between the SAP and the home AAA server 60. Hence, such a delay can adversely affect the overall network performance. Thus, the conventional method, such as illustrated in FIG. 1, can cause delays due to the signal exchanges between the SAP and the home AAA server 60 by way of the local AAA server 50.

### SUMMARY OF THE INVENTION

Aspects of the invention have been provided to promote solving the above-mentioned and/or other problems and disadvantages, such as by providing an authentication and authorization method and apparatus in a network system to promote improving efficiency by processing an authorized service list (ASL) and automatically generating security keys to protect the services.

According to an aspect of the present invention, an authentication and authorization method in a network system which includes a mobile terminal and a home authentication, authorization and accounting (AAA) server, includes: receiving a network access service request signal from the mobile terminal; forwarding the received network access service request signal to the home AAA server which corresponds to the network access service request signal; receiving a service list corresponding to the network access service request signal; and sending a network access service authorization signal to the mobile terminal when the service authorization of the mobile terminal is verified or determined based on the received service list.

In a further aspect of the invention, the authentication and authorization method can include creating, by the mobile terminal, a service key which is used to secure a selected service request signal after receiving the network access service authorization signal. Also, the authentication and authorization method according to an aspect of the invention can include creating a service key which is used to secure a service authorization signal with respect to the selected service request signal when the selected service request signal is received from the mobile terminal.

In an additional aspect of the invention, the authentication and authorization method can further include sending, by the mobile terminal, the network access service request signal to a service access point, and the service access point can be a network access server.

In various aspects of the invention, the authentication and authorization method can further include forwarding a corresponding service authorization signal according to a received authorized service list (ASL) of the mobile terminal when the selected service request signal is received from the mobile terminal. The authentication and authorization method, in an aspect of the invention, can further include forwarding, by the mobile terminal, the selected service request signal to the service access point, and the service access point can be one of a network access server, a home agent, and a session initiation protocol (SIP) server. Also, the ASL can include a service code of the authorized service.

In other aspects of the invention, a network system includes: a local authentication, authorization and accounting (AAA) server which receives a network access service request signal from a mobile terminal and forwards the received network access service request signal according to information of the network access service request signal; and a home AAA server which receives the forwarded network access service request signal and sends a service list corresponding to the network access service request signal to the local AAA server. The local AAA server sends a network access service authorization signal to the mobile terminal when the service authorization of the mobile terminal is verified or determined based on the received service list.

In aspects of the invention, the mobile terminal can create a service key which is used to secure a selected service request signal after receiving the network access service authorization signal. Also, the local AAA server can create a service key which is used to secure the corresponding service authorization signal with respect to the selected service request signal when the selected service request signal is received from the mobile terminal. Further, the network system can further include a service access point which receives the network access service request signal from the mobile terminal, and the service access point can be a network access server.

In various aspects of the invention, the local AAA server can forward a corresponding service authorization signal according to a received authorized service list (ASL) of the mobile terminal when the selected service request signal is received from the mobile terminal. The network system can further include a service access point which receives the selected service request signal from the mobile terminal. The service access point can be one of a network access server, a home agent, and a session initiation protocol (SIP) server. The ASL can include a service code of the authorized service. Also, the local AAA server can add additional authorized services to the ASL, and these are the services that typically the home AAA server does not necessarily care, or is not necessarily aware of, their being added as additional authorized services, such as complimentary local services, for example.

Additional aspects and/or advantages of the invention are set forth in or are evident from the description which follows, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a signal flow diagram illustrating a conventional authentication and authorization method in a network system;

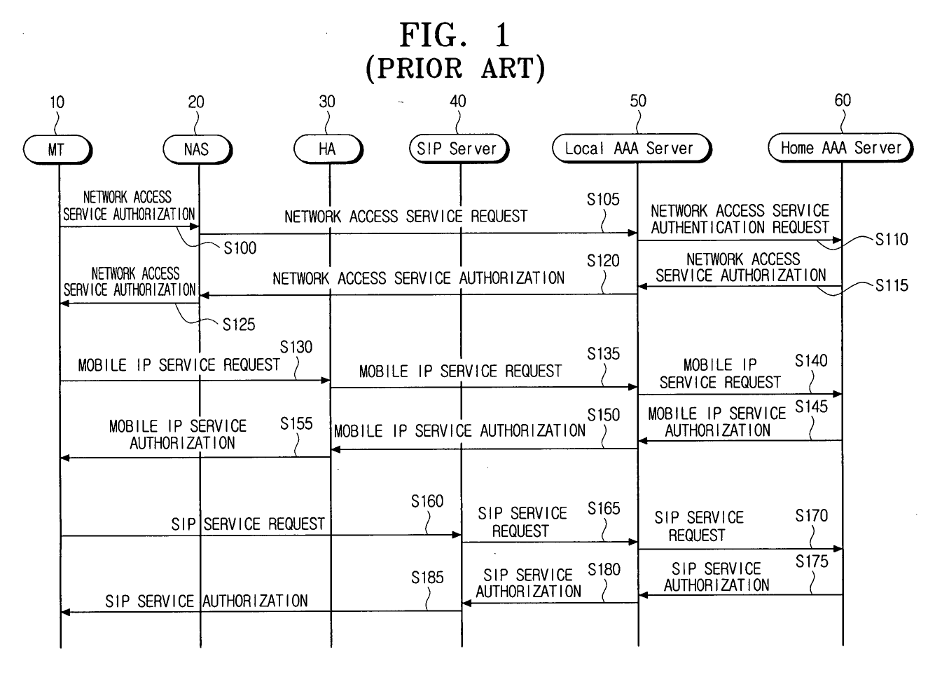

FIG. 2 is a signal flow diagram illustrating an authentication and authorization method and apparatus in a network system according to an embodiment of the invention; and

FIG. 3 is a detailed signal flow diagram illustrating an authentication and authorization method and apparatus in the network system shown in FIG. 2 according to an embodiment of the invention.

### DETAILED DESCRIPTION OF THE EMBODIMENTS

Reference will now be made in detail to aspects and embodiments of the invention, examples of which are illustrated in the accompanying drawings, wherein like reference numerals refer to the like elements throughout. Various embodiments and/or aspects are described below in order to explain the invention by referring to the figures.

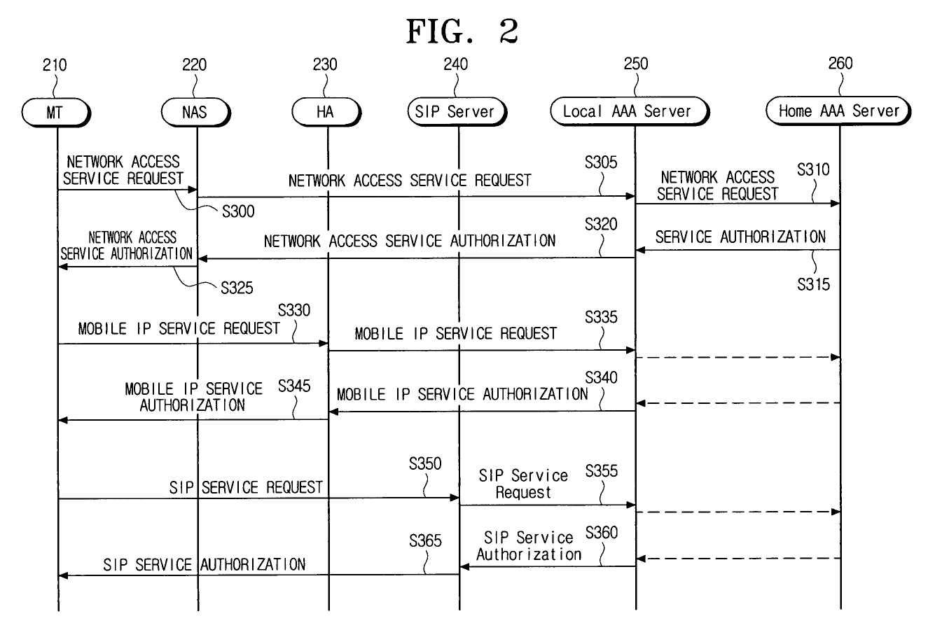

FIG. 2 is a signal flow diagram illustrating an authentication and authorization apparatus and method in a network system according to an embodiment of the invention. The network system includes a mobile terminal (MT) 210, a network access server (NAS) 220, a home agent (HA) 230, a session initiation protocol (SIP) server 240, a local authentication, authorization and accounting (AAA) server 250, and a home AAA server 260.

Continuing with reference to FIG. 2, the authentication and authorization apparatus and method in the network system is explained as follows. When a user requests a network access service, the MT 210 sends a network access service request signal to the NAS 220 at its moved location (operation S300). Upon receiving the network access service request signal from the MT 210, the NAS 220 forwards the received network access service request signal to the local AAA server 250 (operation S305). Upon receiving the network access service request signal from the NAS 220, the local AAA server 250 forwards the received network access service request signal to the home AAA server 260 corresponding to the MT 210 using information relating to the MT 210 (operation S310).

The home AAA server 260 then verifies whether the corresponding MT 210 is authorized for the network access service based on the information relating to the MT 210. When the MT 210 is authorized for the network access service, the home AAA server 260 sends a service authorization signal to the local AAA server 250 (operation S315). As such, the local AAA server 250 needs generally to consult with the home AAA server 260 to authorize the service according to the network access service request. When sending the service authorization signal to the local AAA server 250 at operation S315, the home AAA server 260 additionally sends an authorized service list (ASL) of the corresponding MT 210. The ASL includes a unique service code corresponding to and/or for each service on the ASL.

Upon receiving the service authorization signal and the ASL from the home AAA server 260, the local AAA server 250 verifies that the corresponding MT 210 is authorized for the network access service from the ASL, and forwards a network access service authorization signal to the NAS 220 (operation S320). The NAS 220 then forwards the received network access service authorization signal to the MT 210 (operation S325), when the service is authorized.

Therefore, when the user needs a mobile IP service, the MT 210 sends a mobile IP service request signal to the HA 230 (operation S330). Upon receiving the mobile IP service request signal from the MT 210, the HA 230 forwards the received mobile IP service request signal to the local AAA server 250 (operation S335). Upon the receipt of the mobile IP service request signal from the HA 230, the local AAA server 250 verifies that the corresponding MT 210 is authorized for the mobile IP service, based on the ASL of the corresponding MT 210 which has been received at operation S315. Next, the local AAA server 250 forwards a mobile IP service authorization signal to the HA 230 (operation S340) and an automatically generated key to secure the current and subsequent Mobile IP signaling. The HA 230 forwards the received mobile IP service authorization signal to the MT 210 (operation S345). Therefore, the network access service authorization, according to aspects of the invention, can be used for subsequent service authorizations, without again submitting a network service access request to the home AAA server 260, so that the service delay due to the AAA protocol exchanges can be reduced.

When the user requests a session initiation protocol (SIP) service, the MT 210 sends an SIP service request signal to the SIP server 240 (operation S350). Upon receiving the SIP service request signal from the MT 210, the SIP server 240 forwards the received SIP service request signal to the local AAA server 250 (operation S355). Upon the receipt of the request signal from the SIP server 240, the local AAA server 250 verifies that the corresponding MT 210 is authorized for the SIP service, based on the ASL of the corresponding MT 210 which has been received at operation S315. Next, the local AAA server 250 forwards a SIP service authorization signal to the SIP server 240 (operation S360), when the service is authorized. The SIP server 240 then forwards the received SIP service authorization signal to the MT 210 (operation S365).

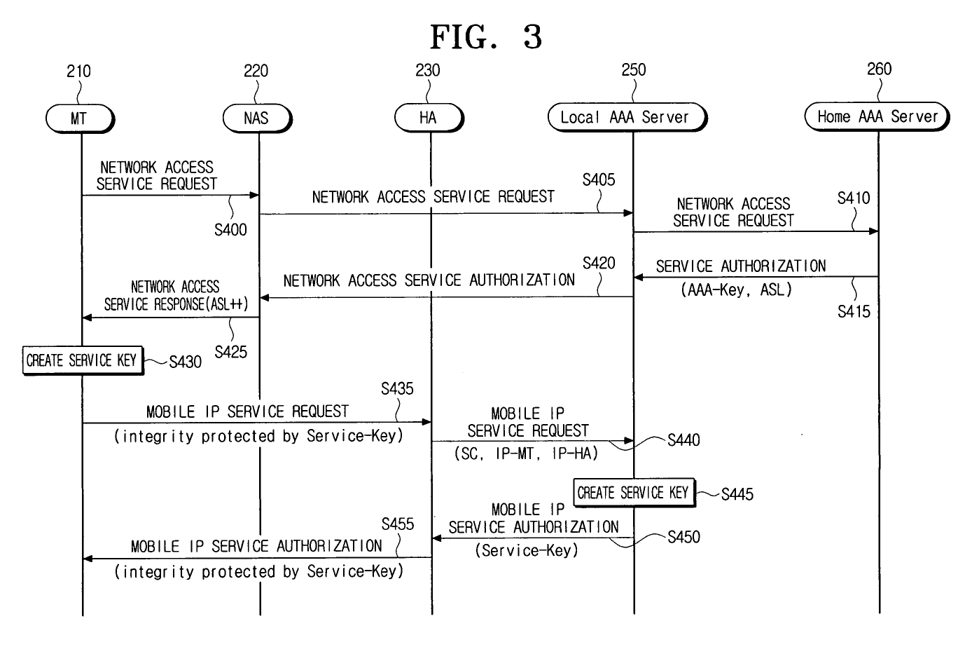

FIG. 3 is a detailed signal flow diagram illustrating an authentication and authorization apparatus and method in a network system according to an embodiment of the present invention. Referring to FIG. 3, when the user requests a network access service, the MT 210 sends a network access service request signal to the NAS 220 at its moved location (operation S400). Upon receiving the network access service request signal from the MT 210, the NAS 220 forwards the received network access service request signal to the local AAA server 250 (operation S405). Upon receiving the network access service request signal from the NAS 220, the local AAA server 250 forwards the received network access service request signal to the home AAA server 260 corresponding to the MT 210 using information relating to the MT 210 (operation S410).

The home AAA server 260 then verifies or determines whether the corresponding MT 210 is authorized for the network access service based on the information relating to the MT 210. When the MT 210 is authorized for the network access service, the home AAA server 260 sends a service authorization signal to the local AAA server 250 (operation S415). As described earlier, when sending the service authorization signal to the local AAA server 250 at operation S415, the home AAA server 260 additionally sends an authorized service list (ASL) of the corresponding MT 210. The ASL includes a unique service code corresponding to and/or for each service on the ASL. In the embodiment of the present invention, illustrated in FIG. 3, the home AAA server 260 also sends a created authentication, authorization and accounting (AAA)-key together with the service authorization signal and the ASL at operation S415, with the AAA-key corresponding to the authorized service list (ASL). The AAA-key from the home server 260 can be used to secure a service authorization signal corresponding to a selected service request signal from the MT 210. In this case, the local AAA server 250 holds the AAA-key, as well.

Upon the receipt of the service authorization signal and the ASL from the home AAA server 260, the local AAA server 250 can optionally extend the ASL provided by the AAA server 260 by including additional service codes based on the access network configuration. The extended ASL by the local AAA server 250 is useful when the local access network is willing to provide additional authorized services that are not included on the ASL from the home AAA server 260 that the home AAA server 260 does not necessarily care, or is not necessarily aware of, their being added as additional authorized services. Also, as previously mentioned, the network access service authorization, according to aspects of the invention, can be used for subsequent service authorizations, without again submitting a network service access request to the home AAA server 260, so that the service delay due to the AAA protocol exchanges can be reduced.

Based on the complete ASL (ASL++), the local AAA server 250 verifies that the corresponding MT 210 is authorized for the network access service and sends to the NAS 220 a network access service authorization signal together with the complete ASL++ (operation S420). When the home AAA server 260 has sent the service authorization signal and the ASL together with its created AAA-key to the local AAA server 250 at operation S415, the local AAA server 250 also forwards the received AAA-key to the NAS 220. The local AAA server 250 can also create an AAA-service key, which can correspond to the extended or complete ASL (ASL++). The AAA-key created by the local AAA server 250 can be used to secure a service authorization signal corresponding to a selected service request, when the selected service request is received from the MT 210.

Next, the NAS 220 forwards the network access service authorization signal and the complete ASL++ to the MT 210 (operation S425). The complete ASL++ received by the MT 210 signifies the list of local services available to the user. When the MT 210 requests secure access to any one of the available local services as, for example the mobile IP service in FIG. 3, the service access point (SAP) is the HA 230, and the MT 210 derives a service key from the received AAA-key based on Equation 1 (operation S430), as follows.
Service Key=HMAC-SHA1(AAA Key, SC, IP Addr of SAP, IP Addr of MT) [Equation 1]

In Equation 1, Service Key denotes the service key, HMAC-SHA1 denotes a one-way hash function according to an embodiment of the invention, and AAA Key denotes the AAA-key. SC denotes the service code, IP Addr of SAP denotes an IP address of the SAP, and IP Addr of MT denotes an IP address of the MT 210.

Then, the MT 210 secures a mobile IP service request signal using the service key and sends the encrypted mobile IP service request signal to the HA 230 (operation S435). At this time, the service request signal of the MT 210 can be protected using the derived service key. Meanwhile, since the HA 230 which is the SAP typically cannot verify the authentication and the authorization of the IP service request, the HA 230 sends the service code (SC), the IP address of the SAP, and the IP address of the MT 210 to the local AAA server 250 (operation S440).

When the complete ASL++ of the MT 210 includes a service code corresponding to the service request, the local AA server 250 creates a service key in the same or similar manner as by the MT 210 (operation S445). Next, the local AAA server 250 sends the created service key together with a mobile IP service authorization signal to the HA 230 which is the SAP (operation S450). The HA 230 verifies the authorization of the service request from the mobile IP service authorization signal and forwards the received service authorization signal to the MT 210 (operation S455). The service authorization signal forwarded at operation S455 is encrypted using the received service key and thus its security is maintained. The service key shared by the MT 210 and the HA 230 being the SAP can be used as a secret, or secured, key for the corresponding relevant service.

In embodiments and/or aspects of the invention, the signal exchanges for the authentication and the authorization between the local AAA server 250 and the home AAA server 260 can be omitted after the first network access authorization. In the above descriptions, the service can be a network access service, a mobile IPv6 service, a SIP service, a mobile IPv6 service and the like.

Further, aspects and/or embodiments of the invention can provide additional information to the local AAA server 250 during the first authorization, that is, during the network access authorization, to thus promote effectively reducing the delay until the user is provided with a next requested service. The additional information can then be utilized to authenticate and authorize the user with respect to supplemental service requests.

Also, additional aspects of the invention can be applied in commercial Internet and intranet access. In this regard, access network architectures are evolving beyond a simple IP forwarding service by incorporating additional services such as mobile IP services on 3GPP2 and WiMAX, and application services on DSL, to which aspects of the invention can be applied. In addition, to augment access service with these supplemental services, service providers can provide differentiated services. For instance, additional differentiated services can be provided according to a service level of users such as gold, platinum, silver and so on. Also, by utilizing aspects of the invention, the service providers can provide the AAA-enabled services without compromising the service performance.

Furthermore, according to aspects of the invention, the base service protocols such as mobile IP, SIP and the like, are typically not adversely affected during the authorization of subsequent service requests. Also, aspects of the authentication and authorization method and apparatus of the invention can be applicable to various protocols and services that can use a shared secret or secured key. In view of this aspect of the invention, the practical availability of the invention can be enhanced. As set forth above, the single network access service authorization, according to aspects of the invention, can be used for subsequent service authorizations so that the service delay due to the AAA protocol exchanges can be reduced.

The foregoing embodiments, aspects and advantages are merely exemplary and are not to be construed as limiting the present invention. Also, the description of the embodiments of the present invention is intended to be illustrative, and not to limit the scope of the claims, and various other alternatives, modifications, and variations will be apparent to those skilled in the art. Therefore, although a few embodiments of the present invention have been shown and described, it would be appreciated by those skilled in the art that changes may be made in the embodiments without departing from the principles and spirit of the invention, the scope of which is defined in the claims and their equivalents.

What is claimed is:

1. An authentication and authorization method in a network system which includes a mobile terminal and a home authentication, authorization and accounting (AAA) server, the method comprising:
receiving a network access service request signal from the mobile terminal;
forwarding the received network access service request signal to the home AAA server which corresponds to the network access service request signal;
receiving a service list corresponding to the network access service request signal; and
sending a network access service authorization signal to the mobile terminal when the service authorization of the mobile terminal is verified based on the received service list.

2. The authentication and authorization method of claim 1, further comprising:
creating, by the mobile terminal, a service key which is used to secure a selected service request signal after receiving the network access service authorization signal.

3. The authentication and authorization method of claim 2, further comprising:
creating, by the home AAA server, a service key which is used to secure a service authorization signal corresponding to the selected service request signal when the selected service request signal is received from the mobile terminal.

4. The authentication and authorization method of claim 1, further comprising:
sending, by the mobile terminal, the network access service request signal to a service access point.

5. The authentication and authorization method of claim 4, wherein the service access point comprises a network access server.

6. The authentication and authorization method of claim 1, further comprising:
forwarding a corresponding service authorization signal according to a received authorized service list (ASL) of the mobile terminal when a selected service request signal is received from the mobile terminal.

7. The authentication and authorization method of claim 6, further comprising:
forwarding, by the mobile terminal, the selected service request signal to a service access point.

8. The authentication and authorization method of claim 7, wherein the service access point comprises one of a network access server, a home agent, and a session initiation protocol (SIP) server.

9. The authentication and authorization method of claim 6, wherein the ASL includes a service code of an authorized service corresponding to the selected service request signal.

10. The authentication and authorization method of claim 1, further comprising:
adding at least one authorized service to the received service list to comprise an authorized service list (ASL) of the mobile terminal.

11. A network system, comprising:
a local authentication, authorization and accounting (AAA) server to receive a network access service request signal from a mobile terminal and forward the received network access service request signal according to information corresponding to the mobile terminal sending the network access service request signal; and
a home AAA server to receive the forwarded network access service request signal and send a service list corresponding to the network access service request signal to the local AAA server,
wherein the local AAA server sends a network access service authorization signal to the mobile terminal when the service authorization of the mobile terminal is verified based on the received service list.

12. The network system of claim 11, wherein the mobile terminal creates a service key which is used to secure a selected service request signal after receiving the network access service authorization signal.

13. The network system of claim 12, wherein the local AAA server creates a service key which is used to secure a service authorization signal corresponding to the selected service request signal when the selected service request signal is received from the mobile terminal.

14. The network system of claim 11, further comprising:
a service access point to receive the network access service request signal from the mobile terminal.

15. The network system of claim 14, wherein the service access point comprises a network access server.

16. The network system of claim 11, wherein the local AAA server forwards a corresponding service authorization signal according to a received authorized service list (ASL) of the mobile terminal when a selected service request signal is received from the mobile terminal.

17. The network system of claim 16, further comprising:
a service access point to receive the selected service request signal from the mobile terminal.

18. The network system of claim 17, wherein the service access point comprises one of a network access server, a home agent, and a session initiation protocol (SIP) server.

19. The network system of claim 16, wherein the ASL includes a service code of the authorized service corresponding to the selected service request signal.

20. The network system of claim 11, wherein the local AAA server additionally adds at least one authorized service to the received service list to comprise an authorized service list (ASL) of the mobile terminal.

21. The network system of claim 11, wherein the local AAA server sends a network access service authorization signal to the mobile terminal when the service authorization of the mobile terminal is verified based on the received service list for a subsequent service authorization, without again submitting the network access service request signal to the home AAA server.

22. The network system of claim 11, wherein the received service list includes a service code corresponding to an authorized service.

23. The network system of claim 11, wherein the received service list comprises an authorized service list (ASL) of the mobile terminal and includes a service code corresponding to each authorized service of the mobile terminal on the authorized service list (ASL).

24. The network system of claim 23, wherein the local AAA server additionally adds at least one authorized service to the received service list to comprise the authorized service list (ASL) of the mobile terminal.

25. The network system of claim 11, wherein
the home AAA server sends to the local AAA server a service authorization signal that corresponds to the network access service request signal from the mobile terminal, when the home AAA server determines that the network access service is authorized.

26. The network system of claim 25, wherein
the home AAA server sends to the local AAA server an AAA-key corresponding to an authorized service list (ASL) for the mobile terminal.

27. The network system of claim 11, wherein
the mobile terminal creates a service key which is used to secure a selected service request signal after receiving the network access service authorization signal, and
the local AAA server creates a service key which is used to secure a service authorization signal corresponding to the selected service request signal when the selected service request signal is received from the mobile terminal.

28. The network system of claim 27, wherein
the home AAA server sends to the local AAA server an AAA-key corresponding to an authorized service list (ASL) for the mobile terminal.

29. The network system of claim 28, wherein the local AAA server sends a network access service authorization signal to the mobile terminal when the service authorization of the mobile terminal is verified based on the received service list for a subsequent service authorization, without again submitting the network access service request signal to the home AAA server.

30. The network system of claim 27, wherein the local AAA server sends a network access service authorization signal to the mobile terminal when the service authorization of the mobile terminal is verified based on the received service list for a subsequent service authorization, without again submitting the network access service request signal to the home AAA server.

31. An authentication and authorization method in a network system which includes a mobile terminal, a local authentication, authorization and accounting (AAA) server and a home AAA server, the method comprising:
receiving, by the local AAA server, a network access service request signal from the mobile terminal;
forwarding, by the local AAA server, the received network access service request signal to the home AAA server which corresponds to the network access service request signal;
receiving, by the AAA local server from the home AAA server, a service list corresponding to the network access service request signal; and
sending, by the AAA local server, a network access service authorization signal to the mobile terminal when the service authorization of the mobile terminal is verified based on the received service list.

32. The authentication and authorization method of claim 31, further comprising:
when the service authorization of the mobile terminal is verified based on the received service list, for a subsequent service authorization of the mobile terminal, sending by the AAA local server a network access service authorization signal to the mobile terminal without again forwarding by the local AAA server the network access service request signal to the home AAA server.

33. The authentication and authorization method of claim 31, further comprising:
creating, by the mobile terminal, a service key which is used to secure a selected service request signal after receiving the network access service authorization signal.

34. The authentication and authorization method of claim 33, further comprising:
creating, by the local AAA server, a service key which is used to secure a service authorization signal corresponding to the selected service request signal when the selected service request signal is received from the mobile terminal.

35. The authentication and authorization method of claim 34, further comprising:
when the service authorization of the mobile terminal is verified based on the received service list, for a subsequent service authorization of the mobile terminal, sending by the AAA local server a network access service authorization signal to the mobile terminal without again forwarding by the local AAA server the network access service request signal to the home AAA server.

36. The authentication and authorization method of claim 35, further comprising:
creating, by the home AAA server, a service key which is used to secure a service authorization signal corresponding to the selected service request signal when the selected service request signal is received from the mobile terminal.

37. The authentication and authorization method of claim 34, further comprising:
creating, by the home AAA server, a service key which is used to secure a service authorization signal corresponding to the selected service request signal when the selected service request signal is received from the mobile terminal.

38. The authentication and authorization method of claim 31, further comprising:
forwarding, by the mobile terminal, a selected service request signal to a service access point; and
forwarding, by the service access point, the selected service request signal to the local AAA server.

39. The authentication and authorization method of claim 38, wherein the service access point comprises one of a network access server, a home agent, and a session initiation protocol (SIP) server.

40. The authentication and authorization method of claim 39, further comprising:
when the service authorization of the mobile terminal is verified based on the received service list, for a subsequent service authorization of the mobile terminal, sending by the AAA local server a network access service authorization signal to the mobile terminal without again forwarding by the local AAA server the network access service request signal to the home AAA server.

41. The authentication and authorization method of claim 31, further comprising:
adding by the local AAA server at least one authorized service to the received service list to comprise an authorized service list (ASL) of the mobile terminal.

42. The authentication and authorization method of claim 41, further comprising:
when the service authorization of the mobile terminal is verified based on the authorized service list (ASL) of the mobile terminal, for a subsequent service authorization of the mobile terminal, sending by the AAA local server a network access service authorization signal to the mobile terminal without again forwarding by the local AAA server the network access service request signal to the home AAA server.

43. An authentication and authorization method in a network system, the method comprising:
sending a network access service request signal from a mobile terminal;
receiving a single network access service authorization comprising a service list in response to the network access service request signal; and
sending, for an initial and for any subsequent service authorization of the mobile terminal, a network access service authorization signal to the mobile terminal based upon the single network access service authorization, when the service authorization of the mobile terminal is verified based on the received service list.
